(19) United States
(12) Patent Application Publication
(10) Pub. No.: US 2024/0281645 A1
(43) Pub. Date: Aug. 22, 2024

(54) METHOD AND APPARATUS FOR ACCELERATING GNN PRE-PROCESSING

(71) Applicant: Korea Advanced Institute of Science and Technology, Daejeon (KR)

(72) Inventors: Myoungsoo JUNG, Daejeon (KR); Seungkwan Kang, Daejeon (KR); Donghyun Gouk, Daejeon (KR); Miryeong Kwon, Daejeon (KR); Hyunkyu Choi, Daejeon (KR); Junhyeok Jang, Daejeon (KR)

(73) Assignee: Korea Advanced Institute of Science and Technology, Daejeon (KR)

(21) Appl. No.: 18/450,497

(22) Filed: Aug. 16, 2023

(30) Foreign Application Priority Data
Feb. 17, 2023 (KR) 10-2023-0021577

(51) Int. Cl. G06N 3/0495

(52) U.S. Cl. CPC G06N 3/0495

(57) ABSTRACT

Provided is an apparatus for accelerating graph neural network (GNN) pre-processing, the apparatus including a conversion unit configured to convert an original graph in a coordinate list (COO) format into a graph in a compressed sparse row (CSR) format, a sub-graph generation unit configured to generate a sub-graph with a reduced degree of the graph in the CSR format, and an embedding table generation unit configured to generate an embedding table corresponding to the sub-graph.

### CROSS-REFERENCE TO RELATED APPLICATIONS

This application is based on and claims priority under 35 U.S.C. § 119 to Korean Patent Application No. 10-2023-0021577, filed on Feb. 17, 2023, in the Korean Intellectual Property Office, the disclosure of which is incorporated by reference herein in its entirety.

### BACKGROUND

### 1. Field

The disclosure relates to a method of accelerating and automating graph neural network (GNN) pre-processing.

This study has been carried out under Samsung Future Technology Development Project (Task Number: SRFC-IT2101-04).

### 2. Description of the Related Art

A graph neural network (GNN) enables generalization of an existing deep learning system such as a deep neural network (DNN) by learning information about a graph. A GNN operation requires GNN pre-processing before GNN processing. However, most time in the GNN operation is consumed to perform GNN pre-processing rather than to perform the GNN operation.

### SUMMARY

The disclosure is provided to accelerate and automate a GNN pre-processing process.

Additional aspects will be set forth in part in the description which follows and, in part, will be apparent from the description, or may be learned by practice of the presented embodiments of the disclosure.

According to an aspect of the disclosure, a method of accelerating graph neural network (GNN) pre-processing includes converting, by a conversion unit, an original graph in a coordinate list (COO) format into a graph in a compressed sparse row (CSR) format, generating, by a sub-graph generation unit, a sub-graph by reducing a degree of the graph in the CSR format, and generating, by an embedding table generation unit, an embedding table corresponding to the sub-graph.

In an embodiment of the disclosure, the converting may include receiving, by the set-partitioning accelerator, vertex identifications (VIDs) of a source node and a destination of the original graph in the COO format, (Source VID, Destination VID), and sorting the original graph in the COO format based on the Source VID or the Destination VID to generate a COO array, merging, by a merger, the COO array, and converting, by the CSR converter, the COO array merged after the sorting, into the CSR format to generate the graph in the CSR format.

In an embodiment of the disclosure, the method may further include selecting, by the set-partitioning accelerator, some nodes of a neighbor node array of a batch node from the graph in the CSR format, performing uniform random sampling thereon, and generating the sub-graph including the selected nodes. In an embodiment of the disclosure, new consecutive VIDs may be assigned respectively to the selected nodes of the sub-graph.

In an embodiment of the disclosure, the method may further include generating, by the embedding table generation unit, a sampled form of the original embedding table, consisting of the embeddings of the selected nodes of the sub-graph. The sampled embedding table may be sorted in order of the new consecutive VIDs assigned to the selected nodes.

According to another aspect of the disclosure, an apparatus for accelerating graph neural network (GNN) pre-processing includes a conversion unit configured to convert an original graph in a coordinate list (COO) format into a graph in a compressed sparse row (CSR) format, a sub-graph generation unit configured to generate a sub-graph with a reduced degree of the graph in the CSR format, and an embedding table generation unit configured to generate an embedding table corresponding to the sub-graph.

According to another aspect of the disclosure, an apparatus for accelerating graph neural network (GNN) pre-processing includes a set-partitioning accelerator configured to sort each edge of an original graph stored in a coordinate list (COO) format by a node number and perform uniform random sampling on some nodes of a given node array and a compressed sparse row (CSR) converter configured to convert edges sorted by the node number into a CSR format.

In an embodiment of the disclosure, the apparatus may further include a re-indexing unit configured to assign new consecutive vertex identifications (VIDs) respectively to nodes selected through the uniform random sampling.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an internal structural diagram of an apparatus for accelerating graph neural network (GNN) pre-processing, according to an embodiment;

FIG. 2 is an example illustrating a conversion unit that performs conversion, according to an embodiment;

FIG. 3 is an example illustrating a sub-graph generation unit that generates a sub-graph with a reduced degree through equivalent random sampling, according to an embodiment;

FIG. 4 is an example illustrating new consecutive vertex identifications (VIDs) that are assigned to a sub-graph, according to an embodiment;

FIG. 5 is an example illustrating an apparatus for accelerating GNN pre-processing implemented with hardware, according to an embodiment;

FIG. 6 is an internal structural diagram of a set-partitioning accelerator according to an embodiment;

FIG. 7 is an example illustrating uniform random sampling performed by using a set partitioning accelerator according to an embodiment;

FIG. 8 is a flowchart of a method of accelerating GNN pre-processing, according to an embodiment;

FIG. 9 is a flowchart for converting a coordinate list (COO) format into a compressed sparse row (CSR) format in an apparatus for accelerating GNN pre-processing, according to an embodiment; and

FIG. 10 is an internal structural diagram of an embedding table generation unit, according to an embodiment.

### DETAILED DESCRIPTION

Reference will now be made in detail to embodiments, examples of which are illustrated in the accompanying drawings, wherein like reference numerals refer to like components throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of components, modify the entire list of components and do not modify the individual components of the list.

Hereinafter, a description will be made with reference to the drawings.

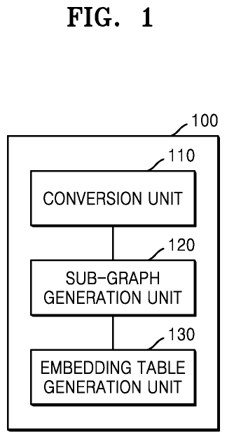

FIG. 1 is an internal structural diagram of an apparatus for accelerating graph neural network (GNN) pre-processing, according to an embodiment.

An apparatus 100 for accelerating GNN pre-processing may include a conversion unit 110, a sub-graph generation unit 120, and an embedding table generation unit 130.

The conversion unit 110 may convert an original graph in a coordinate list (COO) format into a graph in a compressed sparse row (CSR) format. The COO format may store a graph in the form of an edge-centric data structure, and the CSR format may store a graph in the form of a vertex-centric data structure.

To add new connection to the graph stored in the COO format, a new edge including two vertex identifications (VIDs) may be simply appended, thus facilitating updating.

In the CSR format, as destination nodes of each source node are clustered, it is easy to access destination nodes of a given source node. Such a source-centric feature may make it easy to collect embeddings of destination nodes corresponding to each source node in a GNN inference process. The conversion unit 110 may convert the COO format into the CSR format because the CSR format facilitates graph processing in the GNN inference process.

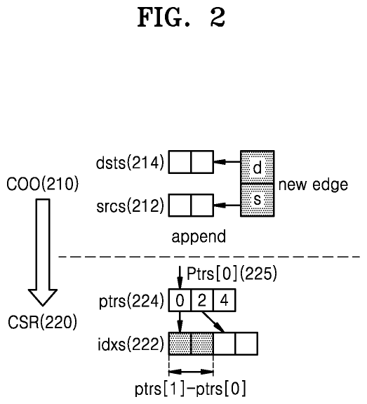

To this end, the conversion unit 110 may sort respective edges of an input original graph by vertex number and perform a data structure conversion process of reconstructing the sorted edges into the CSR format. The conversion unit 110 may convert the original graph in the COO format into the graph in the CSR format each time the graph is updated. An example of converting the COO format into the CSR format by the conversion unit 110 will refer to FIG. 2.

The sub-graph generation unit 120 may sample some nodes less than a preset number in the graph in the CSR format through uniform random sampling to generate a degree-reduced sub-graph. The sub-graph generation unit 120 may search for the graph in the CSR format received from the conversion unit 110. Starting with selecting a batch node, selecting nodes less than a preset number from a neighbor node array of each previously selected nodes may be repeated to perform uniform random sampling. The sub-graph generation unit 120 may generate a sub-graph with a reduced graph degree for each batch.

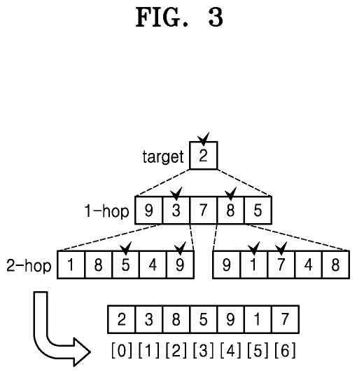

Referring to FIG. 3, starting with uniform random sampling for a batch node ‘2’, nodes ‘3’ and ‘8’ may be selected in a first hop, and uniform random sampling may be performed again in a second hop for each of the nodes ‘3’ and ‘8’ to select nodes ‘5’, ‘9’, ‘1’, and ‘7’.

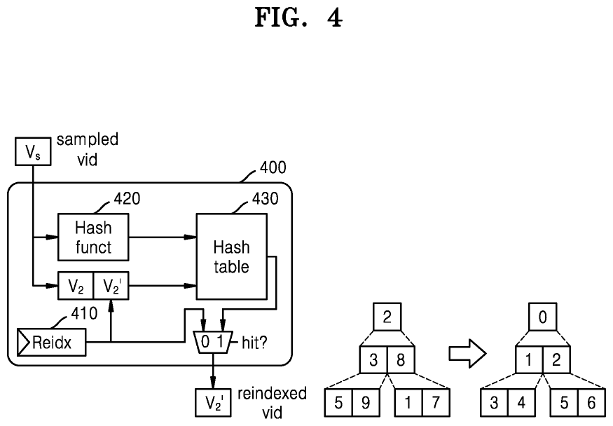

The sub-graph generation unit 120 may assign new consecutive VIDs to nodes of the sub-graph. The VID denotes an index number assigned to each node. Each node of the sub-graph may be assigned with a continuous VID starting from 0 so as to be sorted. An example of generating the sub-graph and assign the VID by the sub-graph generation unit will refer to FIGS. 3 and 4.

The embedding table generation unit 130 may generate an embedding table corresponding to the degree-reduced sub-graph generated by the sub-graph generation unit 120. As each node of the sub-graph generated by the sub-graph generation unit 120 is assigned with a new VID, an embedding table corresponding to the newly assigned VID may be required.

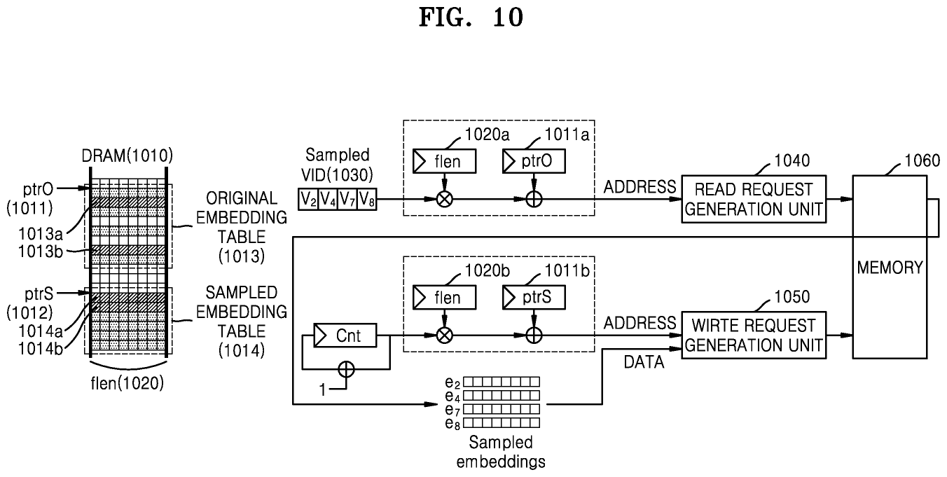

To this end, the embedding table generation unit 130 may generate an embedding table corresponding to a newly generated sub-graph merely with a selected node. The embedding table generation unit 130 may map a VID of the original graph in the COO format to a new VID of each node of the sub-graph to generate an embedding table. An internal structural diagram of the embedding table generation unit 130 will refer to FIG. 10.

FIG. 2 is an example illustrating a conversion unit that performs conversion, according to an embodiment.

Referring to FIG. 2, the original graph may be stored in the form of the edge-centric data structure referred to as a COO 210 to facilitate updating. Each element in the COO format may include VIDs of a source node srcs 212 and a destination node dsts 214.

A format of a CSR 220 may include an index array idxs 222 and a pointer array ptrs 224.

The index array idxs 222 may store a node in a sorted form. For example, destination nodes may be sorted in the order of their source node's VID. Destination nodes having the same source node may be sorted in the order of their destination node's VID. Destination nodes for each source node may be sorted in the order of VIDs.

The pointer array ptrs 224 may store a range of the pointer array ptrs 224 indicated by each destination VID. Referring to FIG. 2, VID 0 may have neighbors from a ptrs[0]^{th} 225 to a (ptrs[1]-1)th index among elements of idxs 222.

FIG. 3 is an example illustrating a sub-graph generation unit that generates a sub-graph with a reduced degree through equivalent random sampling, according to an embodiment. FIG. 3 is an example illustrating the sub-graph generation unit that may select two neighbor nodes among a neighbor node array of a batch node through a 2-hop neighbor sampling process. This is merely an example and the disclosure is not limited thereto. Moreover, 2-hop neighbor sampling taken as an example herein is well known and thus will not be described in detail.

FIG. 4 is an example illustrating a sub-graph generation unit that assigns a new VID to a selected node, according to an embodiment.

A re-indexing unit 400 may include a register 410, a hash function processing unit 420, and a hash table storing unit 430.

A Reidx register 410 may be counted by 1 each time when a node that has not been selected before is input, and may assign a new VID to a newly selected node using this value.

The hash table storing unit 430 may store a VID pair including the original VID and the newly assigned VID. The hash table storing unit 430 may include several entries accessible based on a hash function result processed by the hash function processing unit 420. Each hash table entry may include several slots in which VIDs may be stored, and the several slots may be used for parallel operations.

Upon input of the newly assigned VID, the re-indexing unit 400 may search for a corresponding value in the hash table storing unit 430. When there is no corresponding value, the re-indexing unit 400 may determine a corresponding node as a new node and add the same to a hash table. The value of the Reidx register 410 may be increased by 1 to wait for a new node. When the corresponding value is in the hash table, the original VID may be used as a tag for comparison to determine whether the same node is selected again or collision of the hash function occurs. The re-indexing unit 400 may return mapping information stored in the hash table when the same node is selected again.

In this way, the re-indexing unit 400 may newly label VIDs ‘V₂’, ‘V₃’, ‘V₈’, ‘V₅’, ‘V₉’, ‘V₁’, and ‘V₇’ previously assigned in the original graph respectively to nodes ‘2’, ‘3’, ‘8’, ‘5’, ‘9’, ‘1’, and ‘7’ selected in generation of the sub-graph, with new consecutive VIDs V₀, V₁, V₂, . . . , and V₆.

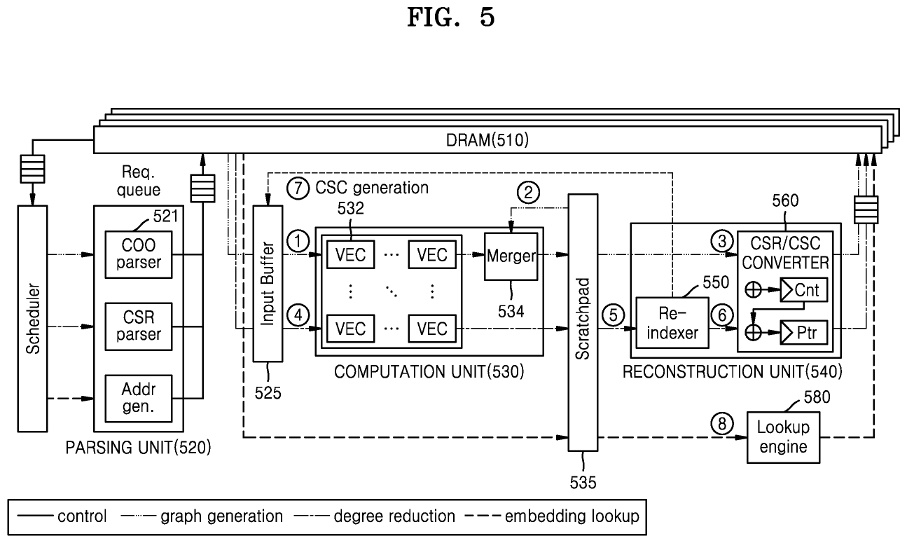

FIG. 5 is an example illustrating an apparatus for accelerating GNN pre-processing implemented with hardware, according to an embodiment. An apparatus 500 for accelerating GNN pre-processing may receive the original graph and the embedding table as inputs from a user, generate a sub-graph with a reduced degree, and provide the generated sub-graph and a new embedding table corresponding thereto. This entire process may be accelerated through hardware.

Referring to FIG. 5, the apparatus 500 for accelerating GNN pre-processing may include a memory 510, a parsing unit 520, a computation unit 530, and a reconstruction unit 540. The reconstruction unit 540 may include a re-indexing unit 550 and a converter 560. The converter 560 may include a CRC converter and a CSC converter. The parsing unit 520 and the reconstruction unit 540 may communicate with the memory 510. The computation unit 530 may include at least one set-partitioning accelerator (vertex-edge processing core (VEC)) 532. The computation unit 530 may further include a merger 534.

The COO parsing unit 521 may read the COO original graph from the memory 510 and parse data into a form understandable by the apparatus 500 for accelerating GNN pre-processing. In FIG. 5, an example of the memory 510 may be a dynamic random access memory (DRAM). The COO parsing unit 521 may receive an address at which the original graph is stored and a size of the original graph as inputs, and transmit a read request for the original graph stored in the COO format to the memory 510. The parsing unit 520 may read the original graph in the COO format and then transmit (Source VID, Destination VID) including VIDs of a source node and a destination node of the original graph to the computation unit 530.

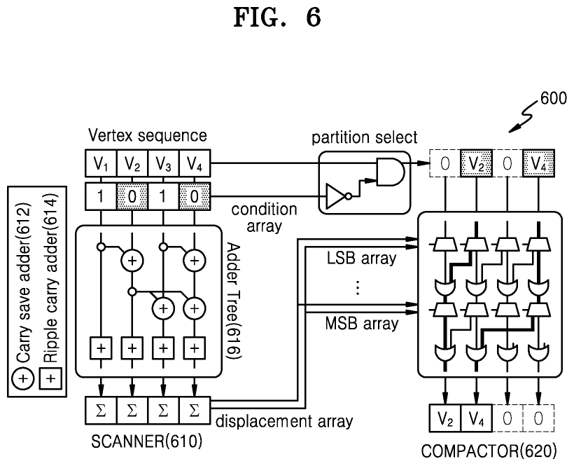

A set-partitioning accelerator 532 may generate a COO array of a preset length by sorting the input (Source VID, Destination VID) based on a source VID or a destination VID. The set-partitioning accelerator 532 may sort the COO array of the specific length within one cycle. To this end, the set-partitioning accelerator 532 may perform scanning and compacting. This will refer to the description of FIG. 6. In an embodiment, the COO array may include both a COO original graph, a COO array read to a certain length, and an array sorted by merging the COO array of the certain length. The COO original graph may be read in the unit of a COO array of a short length.

The merger 534 may merge the sorted COO arrays of the preset length. The merger 534 may receive preset a (a natural number greater>1) COO arrays from the set-partitioning accelerator 532 and merge the a COO arrays to output one sorted COO array.

When the COO original graph is so large to exceed a COO arrays that may be merged at a time by the merger 534, the merger 534 may first merge the a COO arrays and store them in the buffer 535 and secondarily re-input a COO array sorted into one by first merging the a COO arrays to the merger 535.

The CSR converter 560 may read the sorted COO array one by one to convert the same into the graph in the CSR format. The converted graph in the CSR format may be transmitted to the memory 510. The converted graph in the CSR format may be used for an immediately next operation and thus may be transmitted to a parsing unit or a computation unit without being transmitted to the memory.

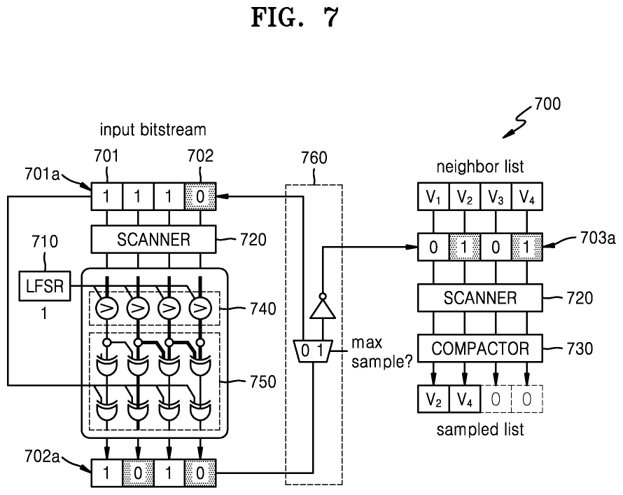

The set-partitioning accelerator 532 may select a preset number of nodes of a neighbor node array of a batch node to perform uniform random sampling. An example of performing uniform random sampling by the set-partitioning accelerator 532 will refer to FIG. 7. The set-partitioning accelerator 532 may generate a sub-graph including the selected nodes. The set-partitioning accelerator 532 may perform a process of reducing a degree of a graph for each batch. The re-indexing unit 550 may assign a new VID to each of the selected nodes of the sub-graph. An example of assigning a new VID in the re-indexing unit 550 will refer to FIG. 4.

In another embodiment, when GNN learning is performed, a compressed sparse column (CSC) format graph of the degree-reduced graph is required. In this case, the re-indexing unit 550 may re-transmit the selected nodes of the sub-graph to the computation unit 530 and sort them, and the CSC converter 560 may convert them into the CSC format.

The apparatus 500 for accelerating GNN pre-processing may generate an embedding table corresponding to the sub-graph generated by the set-partitioning accelerator 532. The parsing unit 510 may transmit a read request for embeddings corresponding to the original VIDs of the selected nodes of the sub-graph to the memory 510. The memory 510 may transmit feature vectors of the selected nodes immediately to the embedding lookup engine 580, skipping the computation unit 530. The embedding lookup engine 580 may assign a new VID to each of the selected nodes based on the original VIDs of the selected nodes to generate an embedding table, as in an embodiment of FIG. 4.

FIG. 6 is an internal structural diagram of a set-partitioning accelerator according to an embodiment.

A set-partitioning accelerator 600 may include a scanner 610 and a compactor 620.

The scanner 610 may include an adder. The scanner 610 may scan how far each element has to move from its current position through set partitioning. The distance, or displacement, each element must move is referred to as a displacement array. The compactor 620 may receive the displacement array from the scanner 610 and move each element to the corresponding position.

In an embodiment, the scanner 610 may use a carry save adder 612 to minimize a delay occurring in scanning. The carry save adder 612 may separately output a carry of a previous bit instead of adding the same to the next bit, thereby preventing a delay of carry propagation.

Assuming an input width of N, the scanner 610 may include a row of log N adders. Each row may include N/2 adders, and in an i^{th} row, an adder is in a column where a quotient divided by 2\hat{ }i is even. Each adder in the i^{th} row may be connected to its own column and a column of the greatest multiple of 2\hat{ }i less than the same. Adders in the last row of an adder tree 616 may use a ripple carry adder 614. The scanner 610 may compute a cumulative sum of an input array within one cycle.

Assuming an input width of N, the compactor 620 may include log N rows. Each row may include a multiplexer and an OR gate. The multiplexer may include two outputs in which a multiplexer in the i^{th} row may be connected to an OR gate in the same column as itself and an OR gate in a column to the left from itself by 2\hat{ }(i−1). To a selected pin of each multiplexer, an i^{th} bit may be connected in which a distance to move to the left is expressed as a binary number.

FIG. 7 is an example illustrating uniform random sampling performed in a set partitioning accelerator according to an embodiment.

A set-partitioning accelerator 700 shown in FIG. 7 may further include a comparator 740, a selector 750, and an update unit 760 in addition to the set set-partitioning accelerator 600 shown in FIG. 6. In an input stream of FIG. 7, a selection bit of a node not selected before is expressed as ‘1’ 701 and a selection bit of a selected node is expressed as ‘0’ 702. The set-partitioning accelerator 700 may select one of nodes not selected in the input bitstream by using the scanner 720 and change the selected bit from ‘1’ into ‘0’.

The set-partitioning accelerator 700 may generate a random number r by using a linear feedback shift register (LFSR) 710. The comparator 740 may compare the random number r with a result of the scanner 720 and then select a r^{th} node from among nodes not selected by the selector 750. The update unit 760 may update a selection bit of a newly selected node from ‘1’ into ‘0’. The set-partitioning accelerator 700 may perform repetition until preset s bits are selected at random from the input bitstream, and then perform set-partitioning. FIG. 7 is an example illustrating the set-partitioning accelerator 700 that finally samples (V₂, V₄) among V₁, V₂, V₃, and V₄. In “1110” 701a of the input bitstream, a 4^{th} element has been selected. When the LFSR 710 generates a random number 1, an input array may be 1010 702a upon selection of the second element from the input bitstream “1110”. The update unit 760 may determine whether the selection unit selects a preset maximum number, s, of samples. In case of true, a NOT circuit operation may be applied to the input array 1010 702a to deliver “0101” 703a.

The scanner 720 and the compactor 730 may collect 2^{nd} and 4^{th} nodes (V₂, V₄) by using “0101” 703a. The set-partitioning accelerator 700 may deliver the selected node array (V₂, V₄) to the reconstruction unit 540 of FIG. 5.

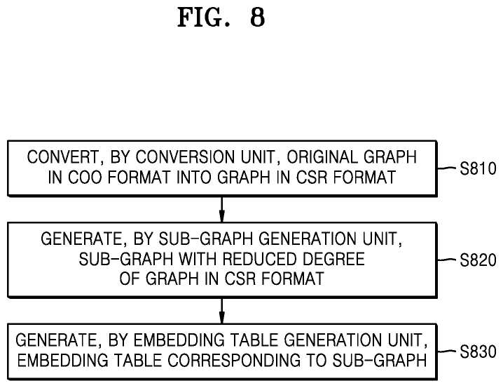

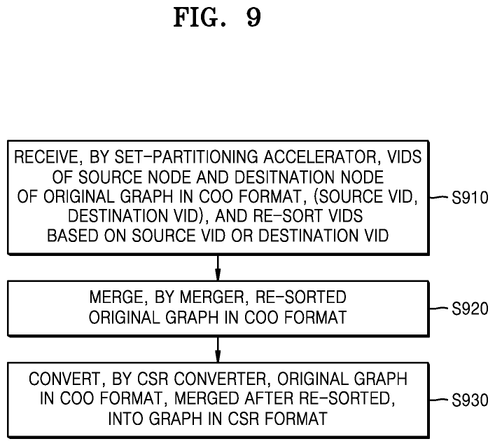

FIG. 8 is a flowchart of a method of accelerating GNN pre-processing, according to an embodiment. The conversion unit may convert the original graph in the stored edge-centric COO format into the node-centric CSR format graph, in operation S810. Referring to FIG. 9, the conversion unit may convert the COO format into the CSR format by using the set-partitioning accelerator, the merger, and the CSR converter.

The set-partitioning accelerator receives VIDs of the source node and the destination of the original graph in the COO format, (Source VID, Destination VID), and sort the original graph in the COO format based on Source VID or Destination VID, in operation S910. In this case, the set-partitioning accelerator may transmit the sorted COO array having a set length n to the merger. The merger may merge the sorted COO arrays in operation S920. The sorted and merged COO array may be transmitted to the CSR converter. The CSR converter may convert the sorted and merged COO array into the graph in the CSR format, in operation S930.

The sub-graph generation unit may generate a sub-graph by reducing a degree of the graph in the CSR format converted by the converter, in operation S820. The embedding table generation unit may generate an embedding table corresponding to the sub-graph, in operation S830.

FIG. 10 is an internal structural diagram of an embedding table generation unit, according to an embodiment.

The embedding table may refer to a table in which embedding vectors of respective nodes are clustered. The embedding vectors are stored at consecutive addresses in order from node 0. All embedding vectors have the same length. In FIG. 10, a length of an embedding vector is flen 1020.

ptrO 1011 indicates a start address of an original embedding table 1013 stored in a DRAM 1010, and ptrS 1012 indicates a start address of an embedding table 1014 stored in the DRAM 1010. The sampled embedding table 1013 may include sampled embeddings 1014a and 1014b obtained by sampling sampled embeddings 1013a and 1013b in an original embedding table 1014.

The embedding table generation unit may receive VIDs of sampled nodes, V₂, V₄, V₇, and V₈, and multiply them by the length of the embedding vector, flen 1020a, and add ptrO 1011a thereto, thus obtaining am embedding start address. A read request generation unit 1040 may transmit a read request for reading data to a length of an embedding vector from the embedding start address to a memory 1060. The read embeddings e₂, by using the embedding target address e₈ may be temporarily stored in a buffer.

When transmitting a write request, the embedding table generation unit may store an embedding read from an address as far as the length of the embedding vector, starting from ptrS 1011b. To this end, a counter register cnt may count a total number of embeddings stored so far.

A length of the embedding vector, flen 1020b, may be multiplied to the counter register cnt and ptrS 1011b may be added thereto, thus obtaining an embedding target address. A write request generation unit 1050 may transmit a write request to the memory 1060 by using the embedding target address and e₂, e₄, e₇, and e₈ stored in the buffer.

The apparatus described above may be implemented by a hardware element, a software element, and/or a combination of the hardware element and the software element. For example, the apparatus and elements described in the embodiments may be implemented using one or more general-purpose or special-purpose computers such as, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. A processing device may execute an operating system (OS) and one or more software applications running on the OS. The processing device may access, store, manipulate, process, and generate data in response to execution of software. For convenience of understanding, it is described that one processing device is used, but those of ordinary skill in the art would recognize that the processing device includes a plurality of processing components and/or a plurality of types of processing components. For example, the processing device may include a plurality of processors or one processor and one controller. Alternatively, other processing configurations such as parallel processors may be possible.

The method according to the embodiments may be implemented in the form of program commands that can be executed through various computer components and recorded in a computer-readable recording medium. The computer-readable recording medium may include a program command, a data file, a data structure and the like solely or in a combined manner. The program command recorded in the computer-readable recording medium may be a program command specially designed and configured for the embodiments or a program command known to be used by those skilled in the art of the computer software field. Examples of the computer-readable recording medium may include magnetic media such as hard disk, floppy disk, and magnetic tape, optical media such as compact disk read only memory (CD-ROM) and digital versatile disk (DVD), magneto-optical media such as floptical disk, and a hardware device especially configured to store and execute a program command, such as read only memory (ROM), random access memory (RAM), flash memory, etc. Examples of the program command may include not only a machine language code created by a complier, but also a high-level language code executable by a computer using an interpreter.

While embodiments have been described by the limited embodiments and drawings, various modifications and changes may be made from the disclosure by those of ordinary skill in the art. For example, even when described techniques are performed in a sequence different from the described method and/or components such as systems, structures, devices, circuits, etc. are combined or connected differently from the described method, or replaced with other components or equivalents, an appropriate result may be achieved. Therefore, other implementations, other embodiments, and equivalents to the claims may also fall within the scope of the claims provided below.

In an embodiment, the apparatus for accelerating GNN pre-processing may accelerate and automate a graph operation for a GNN operation from beginning to end through hardware.

In an embodiment, the apparatus for accelerating GNN pre-processing may transmit data of a pre-processed graph to a host or a model operation accelerator without intervention of a CPU.

In an embodiment, the apparatus for accelerating GNN pre-processing may perform GNN learning as well as GNN inference.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of accelerating graph neural network (GNN) pre-processing, the method comprising:
converting, by a conversion unit, an original graph in a coordinate list (COO) format into a graph in a compressed sparse row (CSR) format;
generating, by a sub-graph generation unit, a sub-graph by reducing a degree of the graph in the CSR format; and
generating, by an embedding table generation unit, an embedding table corresponding to the sub-graph.

2. The method of claim 1, wherein the converting comprises sorting, by a set-partitioning accelerator, the original graph in the COO format and converting, by a CSR converter, the sorted original graph in the COO format into the graph in the CSR format.

3. The method of claim 1, wherein the converting comprises:
receiving, by the set-partitioning accelerator, vertex identifications (VIDs) of a source node and a destination of the original graph in the COO format, (Source VID, Destination VID), and sorting the original graph in the COO format based on the Source VID or the Destination VID to generate a COO array;
merging, by a merger, the COO array; and
converting, by the CSR converter, the COO array merged after the sorting, into the CSR format to generate the graph in the CSR format.

4. The method of claim 1, further comprising generating, by a set-partitioning accelerator, the sub-graph comprising nodes selected after uniform random sampling from the graph in the CSR format.

5. The method of claim 4, wherein new consecutive VIDs are assigned respectively to the selected nodes of the sub-graph.

6. The method of claim 5, wherein the sub-graph is converted into the sub-graph in a compressed sparse column (CSC) format.

7. The method of claim 1, wherein the converting is performed each time when a graph is updated.

8. The method of claim 1, wherein the generating of the embedding table comprises generating the embedding table by mapping vertex identifications (VIDs) of the original graph in the COO format with new VIDs of nodes of the sub-graph, the sub-graph comprising the nodes selected in a neighbor node array of a batch node from the graph in the CSR format through uniform random sampling.

9. An apparatus for accelerating graph neural network (GNN) pre-processing, the apparatus comprising:
a conversion unit configured to convert an original graph in a coordinate list (COO) format into a graph in a compressed sparse row (CSR) format;
a sub-graph generation unit configured to generate a sub-graph with a reduced degree of the graph in the CSR format; and
an embedding table generation unit configured to generate an embedding table corresponding to the sub-graph.

10. The apparatus of claim 9, wherein the conversion unit comprises a set-partitioning accelerator configured to sort the original graph in the COO format and convert the sorted original graph in the COO format into the graph in the CSR format.

11. The apparatus of claim 10, wherein the set-partitioning accelerator comprises:
a scanner comprising an adder; and
a compactor configured to move data.

12. The apparatus of claim 10, wherein the set-partitioning accelerator is further configured to select some nodes of a neighbor node array of a batch node from the graph in the CSR format, perform uniform random sampling thereon, and generate the sub-graph comprising the selected nodes.

13. An apparatus for accelerating graph neural network (GNN) pre-processing, the apparatus comprising:
a set-partitioning accelerator configured to sort each edge of an original graph stored in a coordinate list (COO) format by a node number and perform uniform random sampling on some nodes of a given node array; and
a compressed sparse row (CSR) converter configured to convert edges sorted by the node number into a CSR format,
wherein the set-partitioning accelerator is provided as at least one set-partitioning accelerator.

14. The apparatus of claim 13, further comprising a re-indexing unit configured to assign new consecutive vertex identifications (VIDs) respectively to nodes selected through the uniform random sampling.

15. A computer-readable recording medium for implementing a computer program for executing the method of accelerating GNN pre-processing according to claim 1.
